(19) United States
(12) Patent Application Publication
(10) Pub. No.: US 2011/0288953 A1
(43) Pub. Date: Nov. 24, 2011

(54) Method of creating designs via world wide web and article of manufacture therefrom

(76) Inventor: Anthony G. Emerson, West Covina, CA (US)

(21) Appl. No.: 12/806,161

(22) Filed: Aug. 5, 2010

Related U.S. Application Data
(60) Provisional application No. 61/395,981, filed on May 19, 2010.

(51) Int. Cl. G06Q 30/00

(52) U.S. Cl. 705/26.5

(57) ABSTRACT

A web portal for users to join and create their own profile to bring many people together who connect as friends or business connections. In this environment, the user can create designs for a virtual alter-ego that can then be shown on a virtual runway. Others, such as friends, or potential business contacts, will be able to view this page, including the designs and fashion show. Anyone who views the page will have the ability to model the designs on virtual versions of themselves. This provides a means to shop and try on clothing without ever leaving the computer screen. Once an item is found that is desired by the viewer, the item can be created, ordered and delivered through the web portal.

### REFERENCE TO PRIOR APPLICATION

This application claims the priority of provisional application 61/395,981, filed May 19, 2010 entitled METHOD OF CREATING DESIGNS VIA WORLD WIDE WEB AND ARTICLE OF MANUFACTURE THEREFROM by Anthony Emerson.

### BACKGROUND OF THE INVENTION

1. Field of the Invention

The present invention relates to a method for internet social networking that provides a means for a user to create an account, connect with friends and professional contacts wherein the user can create clothing and other creative designs that can be displayed for, purchased from and/or custom made for any connected user.

2. Description of the Prior Art

The internet has allowed for the use of the world wide web to provide ever expanding means of connecting people socially from all around the globe based on limitless commonalities. There are social networks for the sharing of music, the sharing of photographs and in general sharing updates by various users to be seen by other connected users.

At any given time, a connected user can log into a network and see a user's photographs and writings or anything else that is desired to be shared. Furthermore, there are fantasy type websites wherein a user can create an “avatar”, which is basically a virtual version of the user. Many of these computer programs allow the user to change the hair color, skin color, makeup, clothing, etc. of the avatar.

It is the object of the instant invention to provide a network on the world wide web that allows user to connect to each other that also allows for the user to create clothing that can be modeled by a virtual avatar that can be viewed by all connected users. Any connected user can then try on these designs using their own avatars. Furthermore, any connected user can order and purchase any designs made through software provided, thereby creating an article of manufacture through the interface with the website.

### SUMMARY OF THE INVENTION

The instant invention teaches a method of virtually displaying and creating fashion designs comprising the steps of: providing a software program that creates a virtual network utilizing the world wide web wherein single users can create online identities and interact with other users; providing a software program that allows said single users to create an online image of themselves called an avatar; providing a software program that allows said single users to create designs for said avatar to wear and/or display in real time with form fitting fabric as desired; providing a software program that allows said avatar to display said designs in an online fashion show on said virtual network; providing a software program that allows said other users to view said online fashion show; providing a software program that allows said other users to see said designs on said other users' avatars; providing a software program that allows for the creation of a sewing pattern based on said designs and said dimensions of said avatars; providing a software program that allows for the purchase articles of manufacture created from said sewing patterns based on said designs; and delivery of said articles of manufacture to users who have purchased same.

### BRIEF DESCRIPTION OF THE DRAWINGS

This invention can better be understood by reference to the drawings, provided for exemplary purposes, and in which:

FIG. 1 is a flow chart showing the method of the present invention.

### DETAILED DESCRIPTION OF A PREFERRED EMBODIMENT

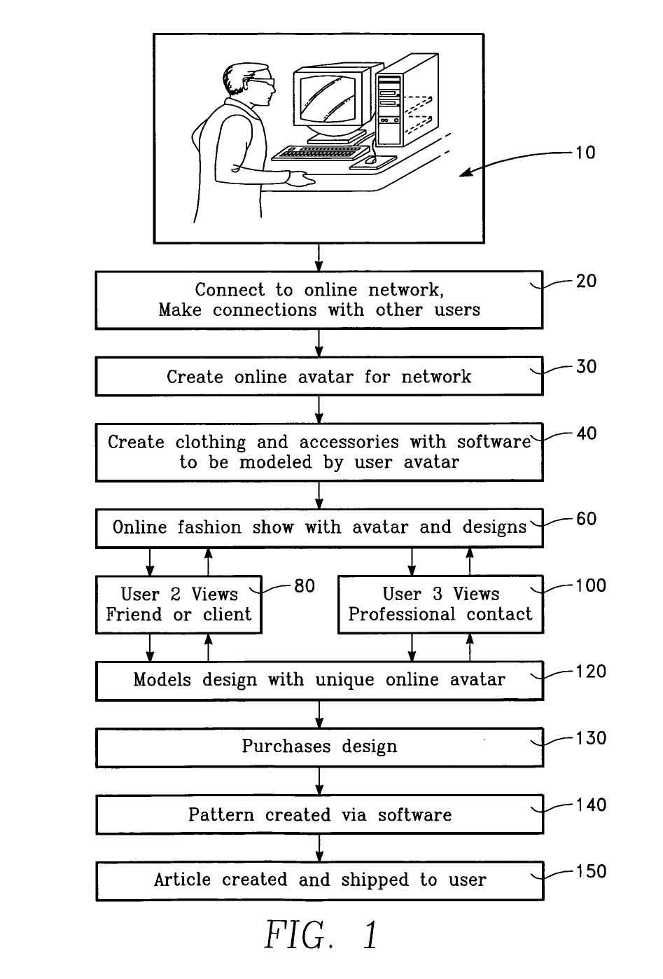

The preferred embodiment of the invention is illustrated in the attached figures. FIG. 1 is a flow chart which demonstrates the steps involved to reach the desired article of manufacture.

Software is used to create a network on the world wide web that allows users to create an account and online identity for the network that can be connected with other users. The user sits at the computer 10 and logs into the network via the world wide web. The user accesses the program and creates his online presence in the network. The user then connects with other users 20, which can be all types of entities, including friends, family and actual or potential business contacts, such as clothing labels, retail outlets, etc.

The user then creates an online avatar 30 for the network which acts as a virtual stand in for the user while on the network. Software is in place on the network allowing the user to create clothing and/or accessories or any other creative work for the avatar to wear and/or display on the network 40. The avatar models and/or displays the creations on the network in a virtual fashion show 60. The designs displayed are created in real time using form fitting fabrics. This removes the time-wasting aspect of prior art design and custom tailoring methods that required time to make adjustments.

Once the fashion show is created, any number of users can now view the show, either a social contact 80 or a potential or current professional contact 100. Users can then try on the designs virtually through their own avatars generated on the site 120. Any user can then purchase any desired designs through the website and its software 130. Additionally, seasonal fashion shows in such renowned worldwide fashion hubs as Paris, Milan and New York will have the ability to incorporate their shows in real time with the online environment created by the instant invention.

Once purchased, software is in place that creates a pattern based on the design and dimensions provided for the avatar and/or the purchase 140. The order and corresponding pattern is subsequently routed to an appropriate source to create the design where the design is created and shipped to the purchaser 150.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

1. A method of purchasing from a directly from a designer a custom tailored article of clothing:
providing a designer with a personal computer;
providing a software program for use in said personal computer that creates a virtual network utilizing the world wide web wherein single users acting as designers or potential purchasers can create online identities and interact with other users through the use of a personal computer;
providing a software program that allows said single users to create an online image of themselves called an avatar;
providing a software program that allows said single users to create designs for said avatar to wear and display;
providing a software program that allows said avatar to display said designs in an online fashion show on said virtual network;
providing a software program that allows said other users to view said online fashion show;
providing a software program that allows said other users to see said designs on said other users' avatars;
providing a software program that allows for the creation of a sewing pattern based on said designs and said dimensions of said avatars;
providing a software program that allows for the purchase articles of manufacture created from said sewing patterns based on said designs; and
delivery of said articles of manufacture to users who have purchased same.

2. The method as defined in claim 1 wherein said designs are created in real time to be form fitting on said avatar.
